(19) United States
(12) Patent Application Publication
(10) Pub. No.: US 2005/0271246 A1
(43) Pub. Date: Dec. 8, 2005

(54) Watermark payload encryption methods and systems

(76) Inventors: Ravi K. Sharma, Portland, OR (US); Daniel O. Ramos, Beaverton, OR (US); Tony F. Rodriguez, Portland, OR (US); Kenneth L. Levy, Stevenson, WA (US)

Correspondence Address: DIGIMARC CORPORATION, 9405 SW GEMINI DRIVE, BEAVERTON, OR, 97008, US

(21) Appl. No.: 11/082,179

(22) Filed: Mar. 15, 2005

Related U.S. Application Data
(63) Continuation-in-part of application No. 10/193,719, filed on Jul. 10, 2002.
(60) Provisional application No. 60/554,541, filed on Mar. 18, 2004.
(60) Provisional application No. 60/558,767, filed on Mar. 31, 2004.

(51) Int. Cl. G06K 9/00; H04L 9/00

(52) U.S. Cl. 382/100; 713/168

(57) ABSTRACT

The present invention provides a method of securing messages steganographically embedded in media (e.g., printed or electronic objects, audio and video). In one implementation, a message includes a first portion and a second portion. The first portion includes a first message and a first checksum, which are encrypted with a private key. The encrypted first portion is combined with the second portion. The second portion includes a second message and as second checksum. The combined encrypted first portion and the second portion form a signature. The signature is encrypted with a common or universal key, perhaps after error correction coding. The private key is uniquely associated with an entity such as a document issuing jurisdiction. In another implementation, a method appends information to a watermark message received from a remote device. The information preferably corresponds to the remote device or to a user of the remote device. In yet another implementation, a method provides standardized watermark payloads from various input data, regardless of the size of the input data.

### RELATED APPLICATION DATA

This patent application is a continuation-in-part of U.S. patent application Ser. No. 10/193,719 (published as US 2003-0033530 A1), filed Jul. 10, 2002. This patent application also claims the benefit of the following U.S. Provisional Patent Application Nos. 60/554,541, filed Mar. 18, 2004, and 60/558,767, filed Mar. 31, 2004.

This patent application is related to the following U.S. patent application Ser. No. 10/020,519, filed Dec. 14, 2001 (published as US 2002-0159614 A1); Ser. No. 09/186,962, filed Nov. 5, 1998, which is a continuation of application Ser. No. 08/649,419, filed May 16, 1996 (now U.S. Pat. No. 5,862,260); and Ser. No. 09/790,322 (published as US 2001-0037313 A1), filed Feb. 21, 2001.

Each of the above patent documents is hereby incorporated by reference.

### TECHNICAL FIELD

The invention relates to digital watermarking, steganography, and specifically to message coding protocols used in conjunction with digital watermarking and steganographic encoding/decoding methods.

### BACKGROUND AND SUMMARY

Digital watermarking is a process for modifying physical or electronic media signals to embed a hidden machine-readable code into the media. The media signal may be modified such that the embedded code is imperceptible or nearly imperceptible to the user, yet may be detected through an automated detection process. Most commonly, digital watermarking is applied to media signals such as images, audio signals, and video signals. However, it may also be applied to other types of media objects, including documents (e.g., through line, word or character shifting), software, multi-dimensional graphics models, and surface textures of objects. Steganography is related field of study pertaining to encoding and decoding of hidden auxiliary data signals, such that the auxiliary data is not discernable by a human.

Digital watermarking systems typically have two primary components: an encoder that embeds the watermark in a host media signal, and a decoder that detects and reads the embedded watermark from a signal suspected of containing a watermark (a suspect signal). The encoder embeds a watermark by subtly altering the host media signal. The reading component analyzes a suspect signal to detect whether a watermark is present. In applications where the watermark encodes information, the reader extracts this information from the detected watermark.

Several particular watermarking and steganographic techniques have been developed. The reader is presumed to be familiar with the literature in this field. Particular techniques for embedding and detecting auxiliary messages in media signals are detailed in the assignee's and U.S. Pat. Nos. 6,614,914 and 6,122,403, which are hereby incorporated by reference.

One practical challenge in the deployment of digital watermarking systems is the potential lack of flexibility in changing aspects of the digital watermark system once it's deployed. As system and application requirements change, there is sometimes a desire to change aspects of the digital watermark message coding protocol. For example, one might want to change the format, syntax, semantics and length of the message payload in the digital watermark. The syntax used in the protocol can include the types and sizes of message fields, as well as the symbol coding alphabet (e.g., use of binary or M-ary symbols, etc.) The semantics used in the protocol refer to the meaning of the message elements in the message payload (e.g., what the elements are interpreted to mean). While such changes may not alter the fundamental data hiding or extraction function, they present a practical difficulty because the deployed digital watermark readers may be rendered obsolete if the protocol is changed.

One potential solution is to upgrade the readers deployed in the field. However, this presents technical challenges, such as whether the readers are accessible and/or re-programmable to receive and facilitate upgrades.

The invention provides variable message protocol methods for digital watermarking. One aspect of the invention is a message protocol method for digital watermarking. This method forms a fixed message protocol portion having a fixed length and identifying a version of a variable protocol portion. The method also forms a variable message protocol portion having variable error robustness message coding format. The version indicates the error robustness coding format of the variable protocol portion. The fixed and variable message protocol portions are then embedded into a host media signal such that the message is substantially imperceptible in the host media signal.

Another aspect of the invention is a method for decoding a digital watermark having fixed and variable protocol message portions. The method extracts a hidden message code embedded in a host media signal by evaluating the host media signal to compute the hidden message code having fixed and variable message protocol portions. It performs error robustness decoding of the fixed protocol portion of the extracted message code to produce one or more message symbols representing a version identifier. Next, it interprets the version identifier to ascertain a version of variable protocol used to embed the variable protocol portion. Finally, it applies an error robustness decoding method of the version to decode message symbols of the variable message protocol portion.

Another aspect of the invention is a message protocol method for steganographically encoding a variable message into a media signal. This method forms a control message portion including at least one symbol that identifies the format of the variable message. It also forms a variable message according to the format. The format indicates a variable length of the variable message portion. The method produces a media signal with the variable message steganographically encoded in it such that the variable message is not discernable by a human but is readable by an automated reader. For example where the media signal is an image, a human viewer is not able to read the variable message encoded in that image because symbols in the variable message are arranged so as not to be interpretable without knowledge of the encoding format.

Still another aspect of the invention is a watermark payload generating method. The method segregates a payload into plural segments—including at least a private segment and a public segment. The private segment is encrypted with a private key, perhaps a key associated with a particular issuing authority (e.g., a jurisdiction). The encrypted private segment is combined (e.g., concatenated or appended to) with the private segment. The combined segments are then encrypted with a public or common key. The watermark payload is then embedded in media (e.g., an image or graphic, audio segment, or video).

Further features will become even more apparent with reference to the following detailed description and accompanying drawings.

### BRIEF DESCRIPTION OF THE DRAWINGS

FIG. 1 is a diagram illustrating an extensible message protocol method for digital watermark embedding.

FIG. 2 is a diagram illustrating a method of extracting a digital watermark message from a host media signal that has been embedded using the method of FIG. 1.

FIGS. 3A and 3B show examples of bit cells used in one form of digital watermark embedding.

FIG. 4 shows a hierarchical arrangement of signature blocks, sub-blocks, and bit cells used in one implementation of a digital watermark message protocol.

FIG. 5 is a diagram illustrating a watermark payload encoding method.

FIG. 6 is a diagram illustrating a watermark payload decoding method. The illustrated decoding method decodes a watermark payload encoded according to the method of FIG. 5.

FIG. 7 shows a system according to an illustrative embodiment of the present invention.

FIG. 8. illustrates a watermark generation process.

### DETAILED DESCRIPTION

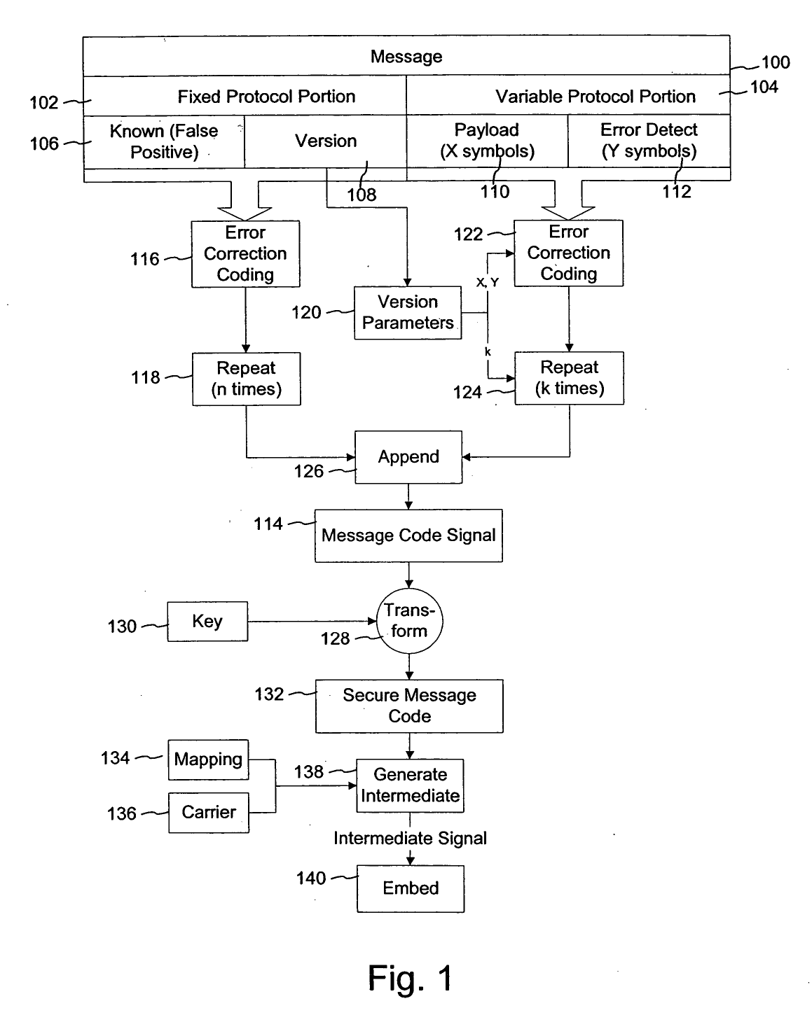

FIG. 1 is a diagram illustrating a message protocol method for digital watermark embedding. The protocol in this context refers to how the message is prepared for digital watermark embedding into a host media signal. One attribute specified by the message protocol is the error robustness coding that is applied to the message. Error robustness coding includes operations on the message that make it more robust to errors that undermine its complete and accurate recovery in potentially distorted version of the watermarked host media signal. Specific forms of error robustness coding include repetition of one or more parts of the message, and error correction coding of one or more parts of the message.

Another aspect of the message protocol is the length of the message payload. The message payload is a variable part of the message. It can be variable in both content (e.g., the values of the individual message symbols in the payload are variable), and length (e.g., the number of symbols is variable). This message payload enables the digital watermark system to convey unique information per watermarked item, such as an item ID, a transaction ID, a variable ASCII character message, etc.

A related aspect of the message protocol is the syntax and semantic meaning of the message elements. As the length of the payload is increased or decreased, the fields within that payload may change, as well as the semantic meaning of the fields. For example, the first N binary symbols may represent a unique ID, while the next M bits represent a source ID or hash of the object in which the information is embedded. As N and M change and other fields are added or deleted, the syntax and semantic meaning of symbols in the payload change.

Yet another aspect of the protocol is the extent to which it facilitates digital watermarking systems that have different message protocols, yet are backward and/or forward compatible with each other. Backward compatibility refers to the case where new versions of the digital watermark reader are able to read messages using the most recently released protocol version, as well as messages in every prior protocol version. Forward compatibility refers to the case where a current version of the digital watermark reader is able to read messages compatible with subsequently released protocol versions. Further examples illustrating this aspect of the protocol follow later.

The method illustrated in FIG. 1 operates with many different forms of digital watermark embedding and detecting operations. In other words, regardless of how the host media signal is modified to embed the result of the message protocol (referred to as the intermediate signal), the message protocol method is widely applicable.

The method of FIG. 1 also operates on different host media signal types and formats. For the sake of illustration, we will use examples of still image watermark embedding that are extendable to other media types, such as motion images (e.g., video) and audio. The method is implemented in software and operates on blocks of the host media signal of a fixed size. These blocks are typically much smaller than the overall size of the host signal, and as such, are tiled or otherwise repeated throughout the host signal to provide an additional layer of robustness beyond the robustness coding within each block.

Since the blocks are of fixed size in our example implementation, there are trade-offs between the length of the variable message payload and the extent of redundancy that may be employed to map that variable message payload into the host media signal of fixed size.

As shown in FIG. 1, the message 100 has a fixed protocol portion 102 and a variable protocol portion 104. The fixed protocol portion includes a fixed message part 106, and a variable message part 108. Each of the parts of the fixed protocol portion has a fixed length, and employs a fixed error robustness coding method. The fixed message part includes a fixed set of known message symbols that serve as a test for false positives (e.g., provide a check to ensure a valid digital watermark is present).

The variable part carries a version identifier 108. This version identifier may carry version parameters, such as an error correction type identifier, a repetition indicator, an error detect indicator or an index that refers to the type of error correction, error detection, and/or repetition applied in the variable protocol portion 104. The variable part of the fixed protocol varies so as to indicate the version of the variable protocol used in processing the variable protocol portion.

The variable protocol portion 104 includes a variable payload part 110 and an error detect part 112. As noted earlier, the payload has a variable number of symbols (X) as specified by the version. The protocol employs a form of error detection, such as a certain type and length of Cyclic Redundancy Check symbols. The variable message protocol portion, therefore, includes a number of error detect symbols (Y).

The message protocol method generates a message code signal 114 by performing error robustness coding on the fixed and variable protocol portions. In the case of the fixed protocol, the method uses a fixed error correction coding method 116 followed by fixed repetition 118 of the resulting message a predetermined number of times (n). While the diagram shows error correction followed by repetition coding, the error robustness coding of the fixed portion may include error correction and/or repetition coding. Examples of error correction coding include block codes (e.g., BCH, Reed Solomon, etc.), convolution codes, turbo codes or combinations thereof.

The version parameters 120 in the illustrated example specify the payload and error detection part lengths, and number of repetitions of the variable portion or individual parts of the variable portion. They may also specify the type of error correction coding to be applied, such as block codes, convolution codes, concatenated codes, etc. As explained further below, some forms of error correction, such as convolution codes, perform error correction in a manner that depends on subsequent symbols in the message symbol string. As such, symbols at the end of the string are error correction decoded with less confidence because there are fewer or no symbols following them. This attribute of error correction coding schemes that have “memory” can be mitigated by repeating parts of the message symbol string that are more susceptible to errors due to the lack of memory than other parts of the message symbol string. As noted, this typically leads to repetition of the tail of the string more than the beginning of the string.

According to the version parameters 120, the protocol method applies a selected error correction coding 122 to the symbols of the variable portion 104, and then applies repetition coding 124 to one or more parts of the error correction coded symbols.

The protocol method then appends 126 the robustness coded fixed and variable portions to form a message code signal 114.

For added security in some applications, the method transforms (128) the message code signal with a secret key. This transformation may include a vector XOR or matrix multiplication of a key 130, such as pseudorandom number that is sufficiently independent from other like key numbers, with the message code signal. The key may be a seed number to a pseudorandom sequence generator, an index to a look up table that produces a vector or matrix, or a vector/matrix, etc. The key serves the function of making the digital watermark un-readable to anyone except those having the proper key. The use of this key enables the digital watermarking protocol to be used for several entities wishing to privately embed and read their own digital watermarks, through the use of their own keys.

The result of the transformation by the key 130 is the secure message code 132. Our example implementation applies an additional transformation to the secure message code before embedding it into the host media signal block. In particular, a mapping function 134 maps elements of the secure message code vector to elements of the host signal block. The elements of the host signal block may be characteristics of individual samples (luminance of pixels or frequency coefficients), or characteristics of groups of samples (statistical features). The carrier signal function 136 transforms the message code elements as a function of corresponding elements of a carrier signal. One such example is spread spectrum modulation of the secure message code with a carrier signal. The carrier signal may have attributes that increase robustness of the watermark (message spreading and scattering as an anti-jamming mechanism), and facilitate detection and geometric synchronization (e.g., autocorrelation properties). The result of transformation by the carrier and mapping functions 138 is an intermediate signal. A digital watermark embedder 140 then modifies characteristics of elements of the host media signal block according to the elements of the intermediate signal to hide the intermediate signal in the host media signal block. There are a wide variety of such embedding methods that may be employed, including those discussed in the documents incorporated by reference. Where perceptual artifacts are a concern, human perceptual modeling may be employed to reduce the perceptibility of artifacts caused by modifying the host media signal block according to the intermediate signal.

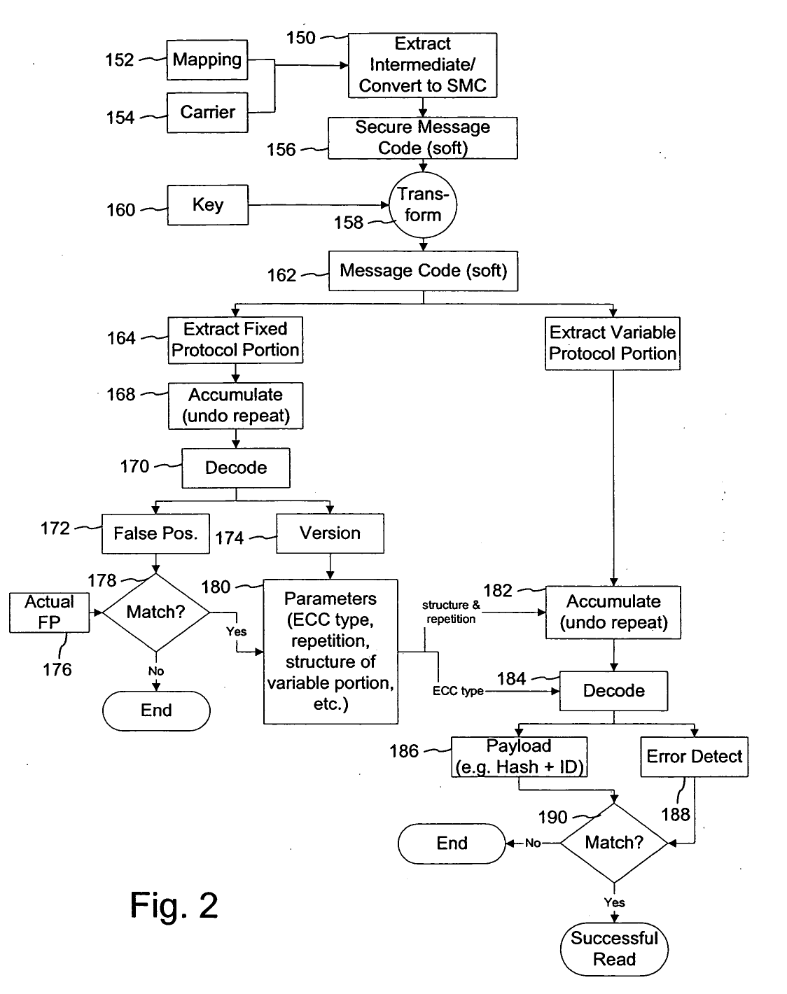

FIG. 2 is a diagram illustrating a method of extracting a digital watermark message from a host media signal that has been embedded using the method of FIG. 1. This method is implemented in a software implementation of a digital watermark reader. The reader extracts estimates of values for the intermediate signal from the host, using a reader 150 compatible with the embedder 140 of FIG. 1. This process may be performed after filtering, synchronizing and generating blocks of the host media signal. In our implementation, the reader 150 extracts estimates of the intermediate signal elements. It then uses the mapping function 152 and carrier signal 154 to convert elements of the intermediate signal embedded in each host media signal block to soft estimates of the secure message code. These elements are soft estimates derived from aggregating elements from the intermediate signal estimate for each corresponding element of the secure message code 156 according to the mapping and carrier functions. In particular, each soft message code element represents a value between S, and −S, where S represents an integer corresponding to binary symbol 1, and −S represents the negative integer corresponding to binary symbol 0.

Next, the reader transforms (158) the secure message code estimate with the key 160. This operation reverses the key transformation 128 applied to the message code in the embedder of FIG. 1. The result is a message code signal estimate, which includes the fixed and variable message protocol portions. The reader extracts these portions (164, 166) and proceeds to apply the fixed protocol to decode the error robustness coding of the fixed protocol portion. This entails accumulation 168 of the repeated message symbols, followed by error correction decoding 170.

The result of the error correction decoding includes a set of fixed symbols (the false positive symbols) 172, and the version identifier 174. The reader compares the extracted fixed symbols with the actual fixed symbols 176, and if there is a match 178, then the version identifier is deemed to be accurate. The reader interprets the version identifier to get the version parameters 180, such as the error correction coding type for the variable protocol, the repetition parameters, the structure of the variable protocol portion, etc. The version parameters may be carried within the version identifier directly or may be accessed via a look-up operation, using the version identifier as an index.

With this version information, the reader proceeds to decode the error robustness coding of the variable protocol portion. This decoding entails, for example, accumulation 182 of the repeated symbols to undo the repetition coding, along with error correction decoding 184 according to the version information. The result of the decoding includes the payload 186 and error detection symbols 188. The reader applies the error detection method to the payload and compares 190 with the error detection symbols to confirm the accuracy of the payload information.

This protocol portion enables the watermarking system to be backward and forward compatible. It is backward compatible because each new version of watermark detector may be programmed to read digital watermarks embedding according to the current version and every prior version of the protocol. It can be forward compatible too by establishing version identifiers and corresponding protocols that will be used in future versions of the system. This enables watermark detectors deployed initially to read the current version of the protocol, as well as future versions of the protocol as identified in the version identifier. At the time of embedding a particular media signal, a digital watermark embedder embeds a version identifier of the protocol used to embed the variable protocol portion. At the time of reading the digital watermark, a reader extracts the version identifier to determine the protocol of the variable protocol portion, and then reads the message payload carried in the variable protocol portion.

Another embodiment of a digital watermarking protocol is described in U.S. Pat. No. 5,862,260, which is incorporated by reference. In this protocol, the digital watermark message includes a control message protocol portion and a variable message protocol portion. The control message includes control symbols indicating the format and length of the variable message protocol portion. The control message protocol and the variable message protocol include symbols that are mapped to locations within a block of the host signal called a “signature” block. As the length of the variable message portion increases, the redundancy of the control message portion decreases.

U.S. Pat. No. 5,862,260 describes a variety of digital watermark embedding methods. One such class of methods for images and video increments or decrements the values of individual pixels, or of groups of pixels (bumps), to reflect encoding of an auxiliary data signal combined with a pseudo random noise signal. One variation of this approach is to embed the auxiliary data—without pseudo randomization—by patterned groups of pixels, termed “bit cells.”

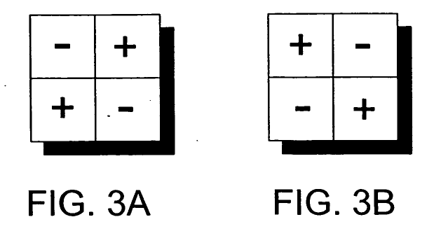

Referring to FIGS. 3A and 3B, two illustrative 2×2 bit cells are shown. FIG. 3A is used to represent a “0” bit of the auxiliary data, while FIG. 3B is used to represent a “1” bit. In operation, the pixels of the underlying image are tweaked up or down in accordance with the ± values of the bit cells to represent one of these two bit values. The magnitude of the tweaking at any given pixel, bit cell or region of the image can be a function of many factors, including human perceptibility modeling, non-linear embedding operations, etc. as detailed in U.S. Pat. No. 5,862,260. In this case, it is the sign of the tweaking that defines the characteristic pattern. In decoding, the relative biases of the encoded pixels are examined using techniques described above to identify, for each corresponding region of the encoded image, which of the two patterns is represented.

While the auxiliary data is not explicitly randomized in this embodiment, it will be recognized that the bit cell patterns may be viewed as a “designed” carrier signal.

The substitution of a pseudo random noise carrier with a “designed” information carrier affords an advantage: the bit cell patterning manifests itself in Fourier space. Thus, the bit cell patterning can act like the subliminal digital graticules discussed in U.S. Pat. No. 5,862,260 to help register a suspect image to remove scale/rotation errors. By changing the size of the bit cell, and the pattern therein, the location of the energy thereby produced in the spatial transform domain can be tailored to optimize independence from typical imagery energy and facilitate detection.

While the foregoing discussion contemplates that the auxiliary data is encoded directly—without randomization by a PRN signal, in other embodiments, randomization can of course be used.

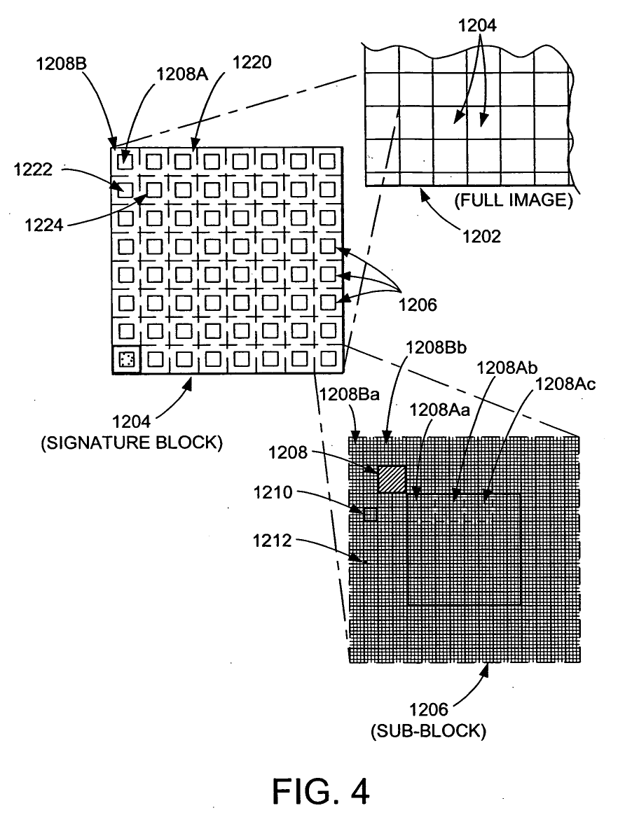

FIG. 4 illustrates an example of a digital watermarking protocol having a message control portion and a variable portion. While this protocol is illustrated using an image, it applies to other media types and digital watermark embedding/reading systems.

Referring to FIG. 4, an image 1202 includes a plurality of tiled “signature blocks” 1204. (Partial signature blocks may be present at the image edges.) Each signature block 1204 includes an 8×8 array of sub-blocks 1206. Each sub-block 1206 includes an 8×8 array of bit cells 1208. Each bit cell comprises a 2×2 array of “bumps” 1210. Each bump 1210, in turn, comprises a square grouping of 16 individual pixels 1212.

The individual pixels 1212 are the smallest quanta of image data. In this arrangement, however, pixel values are not, individually, the data carrying elements. Instead, this role is served by bit cells 1208 (i.e. 2×2 arrays of bumps 1210). In particular, the bumps comprising the bits cells are encoded to assume one of the two patterns shown in FIG. 3. As noted earlier, the pattern shown in FIG. 3A represents a “0” bit, while the pattern shown in FIG. 3B represents a “1” bit. Each bit cell 1208 (64 image pixels) thus represents a single bit of the embedded data. Each sub-block 1206 includes 64 bit cells, and thus conveys 64 bits of embedded data.

The nature of the image changes effected by the encoding follows the techniques set forth in U.S. Pat. No. 5,862,260 under the heading MORE ON PERCEPTUALLY ADAPTIVE SIGNING.

In the illustrated embodiment, the embedded data includes two parts: control bits and message bits. The 16 bit cells 1208A in the center of each sub-block 1206 serve to convey 16 control bits. The surrounding 48 bit cells 1208B serve to convey 48 message bits. This 64-bit chunk of data is encoded in each of the sub-blocks 1206, and is repeated 64 times in each signature block 1204.

A digression: in addition to encoding of the image to redundantly embed the 64 control/message bits therein, the values of individual pixels are additionally adjusted to effect encoding of subliminal graticules through the image. In this embodiment, the graticules discussed in conjunction with FIG. 29A in U.S. Pat. No. 5,862,260 are used, resulting in an imperceptible texturing of the image. When the image is to be decoded, the image is transformed into the spatial domain, a Fourier-Mellin technique is applied to match the graticule energy points with their expected positions, and the processed data is then inverse-transformed, providing a registered image ready for decoding (see U.S. Pat. No. 5,862,260). The sequence of first tweaking the image to effect encoding of the subliminal graticules, or first tweaking the image to effect encoding of the embedded data, is not believed to be critical. As presently practiced, the local gain factors (discussed in U.S. Pat. No. 5,862,260) are computed; then the data is encoded; then the subliminal graticule encoding is performed. Both of these encoding steps make use of the local gain factors.

Returning to the data format, once the encoded image has been thus registered, the locations of the control bits in sub-block 1206 are known. The image is then analyzed, in the aggregate (i.e. considering the “northwestern-most” sub-block 1206 from each signature block 1204), to determine the value of control bit #1 (represented in sub-block 1206 by bit cell 1208 Aa). If this value is determined (e.g. by statistical techniques of the sort detailed above) to be a “1,” this indicates that the format of the embedded data conforms to the standard detailed herein. According to this standard, control bit #2 (represented by bit cells 1208Ab) is a flag indicating whether the image is copyrighted. Control bit #3 (represented by bit cells 1208Ac) is a flag indicating whether the image is unsuitable for viewing by children. Certain of the remaining bits are used for error detection/correction purposes.

The 48 message bits of each sub block 1206 can be put to any use; they are not specified in this format. One possible use is to define a numeric “owner” field and a numeric “image/item” field (e.g. 24 bits each).

If this data format is used, each sub-block 1206 contains the entire control/message data, so same is repeated 64 times within each signature block of the image.

If control bit #1 is not a “1,” then the format of the embedded data does not conform to the above described standard. In this case, the reading software analyzes the image data to determine the value of control bit #4. If this bit is set (i.e. equal to “1”), this signifies an embedded ASCII message. The reading software then examines control bits #5 and #6 to determine the length of the embedded ASCII message.

If control bits #5 and #6 both are “0,” this indicates the ASCII message is 6 characters in length. In this case, the 48 bit cells 1208B surrounding the control bits 1208A are interpreted as six ASCII characters (8 bits each). Again, each sub-block 1206 contains the entire control/message data, so same is repeated 64 times within each signature block 1204 of the image.

If control bit #5 is “0” and control bit #6 is “1,” this indicates the embedded ASCII message is 14 characters in length. In this case, the 48 bit cells 1208B surrounding the control bits 1208A are interpreted as the first six ASCII characters. The 64 bit cells 1208 of the immediately-adjoining sub-block 1220 are interpreted as the final eight ASCII characters.

Note that in this arrangement, the bit-cells 1208 in the center of sub-block 1220 are not interpreted as control bits. Instead, the entire sub-block serves to convey additional message bits. In this case there is just one group of control bits for two sub-blocks

Also note than in this arrangement, pairs of sub-blocks 1206 contains the entire control/message data, so same is repeated 32 times within each signature block 204 of the image.

Likewise if control bit #5 is “1” and control bit #6 is “0”. This indicates the embedded ASCII message is 30 characters in length. In this case, 2×2 arrays of sub-blocks are used for each representation of the data. The 48 bit cells 1208B surrounding control bits 1208A are interpreted as the first six ASCII characters. The 64 bit cells of each of adjoining block 1220 are interpreted as representing the next 8 additional characters. The 64 bits cells of sub-block 1222 are interpreted as representing the next 8 characters. And the 64 bit cells of sub-block 1224 are interpreted as representing the final 8 characters. In this case, there is just one group of control bits for four sub-blocks. And the control/message data is repeated 16 times within each signature block 1204 of the image.

If control bits #5 and #6 are both “1's” , this indicates an ASCII message of programmable length. In this case, the reading software examines the first 16 bit cells 1208B surrounding the control bits. Instead of interpreting these bit cells as message bits, they are interpreted as additional control bits (the opposite of the case described above, where bit cells normally used to represent control bits represented message bits instead). In particular, the reading software interprets these 16 bits as representing, in binary, the length of the ASCII message. An algorithm is then applied to this data (matching a similar algorithm used during the encoding process) to establish a corresponding tiling pattern (i.e. to specify which sub-blocks convey which bits of the ASCII message, and which convey control bits.)

In this programmable-length ASCII message case, control bits are desirably repeated several times within a single representation of the message so that, e.g., there is one set of control bits for approximately every 24 ASCII characters. To increase packing efficiency, the tiling algorithm can allocate (divide) a sub-block so that some of its bit-cells are used for a first representation of the message, and others are used for another representation of the message.

Reference was earlier made to beginning the decoding of the registered image by considering the “northwestern-most” sub-block 1206 in each signature block 1204. This bears elaboration.

Depending on the data format used, some of the sub-blocks 1206 in each signature block 1204 may not include control bits. Accordingly, the decoding software desirably determines the data format by first examining the “northwestern-most” sub-block 1206 in each signature block 1204; the 16 bits cells in the centers of these sub-blocks will reliably represent control bits. Based on the value(s) of one or more of these bits (e.g. the Digimarc Beta Data Format bit), the decoding software can identify all other locations throughout each signature block 1204 where the control bits are also encoded (e.g. at the center of each of the 64 sub-blocks 1206 comprising a signature block 1204), and can use the larger statistical base of data thereby provided to extract the remaining control bits from the image (and to confirm, if desired, the earlier control bit(s) determination). After all control bits have thereby been discerned, the decoding software determines (from the control bits) the mapping of message bits to bit cells throughout the image.

To reduce the likelihood of visual artifacts, the numbering of bit cells within sub-blocks is alternated in a checkerboard-like fashion. That is, the “northwestern-most” bit cell in the “northwestern-most” sub-block is numbered “0.” Numbering increases left to right, and successively through the rows, up to bit cell 63. Each sub-block diametrically adjoining one of its corners (i.e. sub-block 1224) has the same ordering of bit cells. But sub-blocks adjoining its edges (i.e. sub-blocks 1220 and 1222) have the opposite numbering. That is, the “northwestern-most” bit cell in sub-blocks 1220 and 1222 is numbered “63.” Numbering decreases left to right, and successively through the rows, down to 0. Likewise throughout each signature block 1204.

In a variant of this format, a pair of sub-blocks is used for each representation of the data, providing 128 bit cells. The center 16 bit cells 1208 in the first sub-block 1206 are used to represent control bits. The 48 remaining bit cells in that sub-block, together with all 64 bit cells 1208 in the adjoining sub-block 1220, are used to provide a 112-bit message field. Likewise for every pair of sub-blocks throughout each signature block 1204. In such an arrangement, each signature block 1204 thus includes 32 complete representations of the encoded data (as opposed to 64 representations in the earlier-described standard). This additional length allows encoding of longer data strings, such as a numeric IP address (e.g., URL).

Obviously, numerous alternative data formats can be designed. The particular format used can be indicated to the decoding software by values of one or more control bits in the encoded image.

From the foregoing examples, there are a variety of ways to implement variable message protocols. In one approach having a fixed and variable message protocol, the fixed protocol portion is mapped to a fixed part of the host signal, and does not vary in length. In another approach, the number of locations in the host signal used to represent the message control portion decrease as the length of the variable message increases. The control portion may remain fixed, as in the first case, even if the variable message varies in length, by varying the repetition/error correction coding applied to the variable message portion.

Use of Variable Repetition with Error Correction Coding

U.S. patent application Ser. No. 10/020,519 (published as US 2002-0159614 A1) explained that the tail of a convolutionally coded message is more error prone than the rest of the message. One way to make the tail more robust to errors is apply a block error correction code, such as a BCH or other block error correction code, to the tail portion of the message. In this approach, the encoder applies block error correction coding to all, or just the tail of a message sequence, and then follows with convolutional coding of the resulting message sequence. The decoder then reverses this process, effectively using the block error correction to correct errors in the tail of the message.

U.S. patent application Ser. No. 10/139,147 (published as US 2003-0037075 A1) discusses the use of repetition and error correction coding. One way to compensate for the errors in the tail of a convolutionally coded message is to use repetition coding, where symbols of the convolutionally coded message are repeated, and specifically repeated in a variable fashion. The message symbols of the error correction coded message that are more prone to error, such as the tail symbols of the message in a convolutionally coded message, are repeated more than symbols at the beginning or middle of the message.

These approaches extend generally to error correction coding schemes with memory, where lack of memory at a part of the message makes that part more error prone. In particular, selective block coding or variable repetition coding of the error prone part improves the error robustness of the digital watermark message. Block error correction codes, unlike convolutional codes, do not have memory. Memory refers to the attribute of the coding method where subsequent symbols are used to correct errors in previous symbols. Variable repetition coding may be performed on individual error correction coded symbols, or blocks of such symbols. Preferably, more error prone symbols are repeated more than less error prone, error correction coded symbols.

Another way to address the error prone tail part of a convolutionally coded message is to use tail biting codes, where the tail of the coded message loops around to the head or start of the coded message. Such tail biting codes may suffer from being too computationally complex relative to the improvement in error robustness that they can provide.

Returning to the specific approach of using variable repetition, we have experimented with a number of variable repetition assignments for error correction coded symbols of digital watermark messages. A programmatic process generates the assignments from a curve that represents the repetition per symbol position over a sequence of message symbols in a digital watermark message from the start of the message to its end or “tail.” Our experiments show that a variable repetition curve approximating a tan hyperbolic function, comprising constant repetition rate per symbol followed by an increasing repetition rate per symbol, and ending in a constant repetition rate, provides improved error robustness relative to the use of a constant repetition rate throughout the error correction encoded message.

Further experiments show that a variable repetition curve, starting with a constant repetition rate for the beginning of the message, and concluding with a linear increase in the repetition rate at the middle to end of the message also provides improved error robustness.

These curves may be approximated with a staircase shaped curve comprising segments of constant repetition rates at different levels of repletion. In some implementations, these stair case approximations are convenient because they facilitate the use of scrambling/encryption of the output of the repetition coder, and also facilitate decoding of a digital watermark message with fixed and variable protocol portions as described above.

The effect of this approach is to set a variable signal to noise for the error correction coded symbols through variable repetition rates of those symbols. Relative to constant repetition rate coding of error correction coded symbols, this approach achieves a lower effective error rate for the same signal to noise ratio of the digital watermark message signal.

Automated and/or programmatic methods may be used to find optimized variable repetition curves for a given digital watermark message model. Our experience shows that the errors introduced by the digital watermarking channel on the error correction coded message are approximated by white guassian noise. As such, our programmatic processes model the channel, and use general parameters defining characteristics of the curve, to compute the repetition rate per error correction coded symbol that achieves preferred error robustness.

The first step in formulating a repetition rate per symbol curve involves choosing an appropriate model. It is not a requirement to choose a parametric model, but it is a convenience. The principle basis for consideration of a model is that it is monotonically increasing. Further, it should allow flexibility in tuning the initial point of repetition increase as well as the rate of increase, which may or may not be constant. We, for example, have found that both the hyperbolic tangent and the piece-wise linear constant model behave satisfactorily.

Once a model is chosen it remains to vary its parameters until the best behavior in terms of minimum error rate is found. Specifically, if one can model the noise characteristics of the digital watermark message at the input to the convolutional decoder, it is desirable to run many simulations with pseudo-randomly generated noise in order to determine how the model and corresponding choice of parameters behave. If a slight perturbation in the model parameters produces a better simulation effect (e.g., lower error rate), we continue to adjust the parameters in the direction of the perturbation. One programmatic process for converging on an optimized result is a gradient-descent procedure. The model parameters are adjusted using such a procedure, according to perturbation and simulation re-evaluation, until a minimum in the error rate is achieved. In order to avoid problems with local minima on the optimization surface and/or simulation noise, one may wish to perform the search using several different initial parameter configurations. It should be noted that for all choices of models and corresponding parameters, the total number of repetitions should remain fixed. In other words, the area under the repetition curve is constant.

Extensions

The above concepts of protocols with variable robustness coding may be extended to optimize auxiliary data coding applications, including digital watermarking. Generally stated, the approach described in the previous section uses variable robustness coding to reduce the error rate in more error prone parts of a steganographic message. One specific form of variable robustness coding is variable repetition coding of more error prone parts of an error correction coded message.

One variation of this approach is to analyze a model of the channel and/or the host media signal that is communicated through that channel to determine locations within the steganographic code (e.g., embedding locations of a digital watermark) that are likely to be more error prone. In these locations, the steganographic encoding process uses a more robust message coding scheme than in other locations that are less error prone. One specific example is to subdivide the host media signal, such as an image, video frame or audio file into blocks, such as the contiguous tiles described above. Then, the embedder measures the expected error rate for each block, and applies an amount of error robustness coding to the steganographic code mapped to that block corresponding to the expected error rate. Higher error rate blocks have a greater amount of robustness coding, such as more repetition per message symbol. For example, for fixed sized tiles, the error robustness coding increases, resulting in fewer message symbols in the block, but at a higher error robustness level.

The measurement of expected error rate can be modeled based on a model of the channel and/or model of the host signal. For example, the host signal may have certain properties that make the steganographic code embedded in it more error prone for a particular channel. For example, an image that has less variance or energy in a block may be more error prone for a distortion channel that includes printing, scanning, and/or compression. As such, a measure of the variance in the block provides an indicator of the error rate, and thus, an indicator of the type of error robustness coding that need by applied to reduce the error rate. The error robustness, such as the extent of repetition coding or strength of the error correction code is selected to correspond to the desired error rate for the block.

One challenge in supporting such variable robustness coding within blocks of a host signal is the extent to which the auxiliary data decoder (e.g., digital watermark reader) is able to interpret variable robustness coding. This can be addressed by using a message protocol with fixed and variable protocol portions, where the fixed portion in each block specifies the type of error robustness coding used for that block. Alternatively, if the embedder uses a robust measure of achievable capacity for a given error rate, it is possible to determine the amount and/or type of robustness coding that was used at the encoder by observing the data at the auxiliary data decoder. In this way, the decoder can exploit what it knows about the channel, namely, the received host signal carrying the auxiliary data (e.g., an image carrying a digital watermark) and supposed processing noise, in the same fashion that it was exploited at the embedder of the auxiliary data. In particular, if the measure of the expected error rate is likely to be the same at the embedder and the decoder, even after distortion by the channel and the embedding of the auxiliary data, then the decoder can simply re-compute the expected error rate at the receiver, and use this measure to determine the type of error robustness coding that has been applied. In another words, a part of the auxiliary data need not be allocated to identifying the type of error robustness coding if the decoder can derive it from the received signal, the channel, and/or other information available to it.

Watermark Payload Encryption

Some watermark embedding processes begin with a plural-bit message (herein after interchangeably used with “payload”). To simplify the discussion, the message is a binary number suitable for conversion to a watermark signal, e.g., as discussed in assignee's U.S. Pat. No. 6,614,914, herein incorporated by reference. In addition to information conveyed in the message, a watermark embedder may optionally add control bit values (“signature bits”) to the message to assist in verifying the accuracy of a read operation. Bits representing the message, optionally along with any control bits, can be input to an error correction coding process designed to increase the likelihood that a message can be recovered accurately in the reader.

There are several error correction coding schemes that may be employed. Some examples include BCH, convolution, Reed Solomon and turbo codes. These forms of error correction coding are sometimes used in communication applications where data is encoded in a carrier signal that transfers the encoded data from one place to another. In the digital watermarking application discussed here, the raw bit data is encoded in a fundamental carrier signal.

In addition to (or as an alternative to) the error correction coding schemes mentioned above, the embedder may use a checksum process—for example a Cyclic Redundancy Check (CRC)—to facilitate detection of errors in decoded message data.

The error correction coding function produces a string of bits that are embedded into a media signal.

We propose some modifications to the above encoding scheme.

As background, we noticed that some encrypting schemes result in producing larger (encrypted) data from original data. But when dealing with limited bit space—such as a bit-size constrained watermark payload—securely encrypting a watermark payload presents a difficult challenge. We believe that the limited size constraints typically mandated for a watermark payload may preclude the use of some standard encryption techniques for bit-limited watermarking applications.

Thus, we prefer a scrambling or encryption technique (e.g., XOR, etc.) that results in the same or closely constrained bit size as compared to original data. Either a watermark payload or a portion of the payload is manipulated with a key, preferable preserving the original watermark payload size. Without access to the key, data extracted from an encrypted payload remains unintelligible and meaningless. At a watermark embedder, a key is applied to the payload, e.g., after error correction coding. At the detector, a reverse operation is applied. Failure to apply a correct decoding key causes a decoding failure.

We envision applications that segregate or divide a payload into a plurality of portions, perhaps with different levels of security for each portion. The different levels of security are preferably provided through different keys.

Our approach provides a somewhat-closed system, whereby one party (e.g., a passport issuing authority, a credit card company, a private party, etc.) can issue their own “private” key to alter or scramble a message segment. The key is preferably unique to that party. Other information, however, is secured by a key that is shared by many different parties.

Encoding

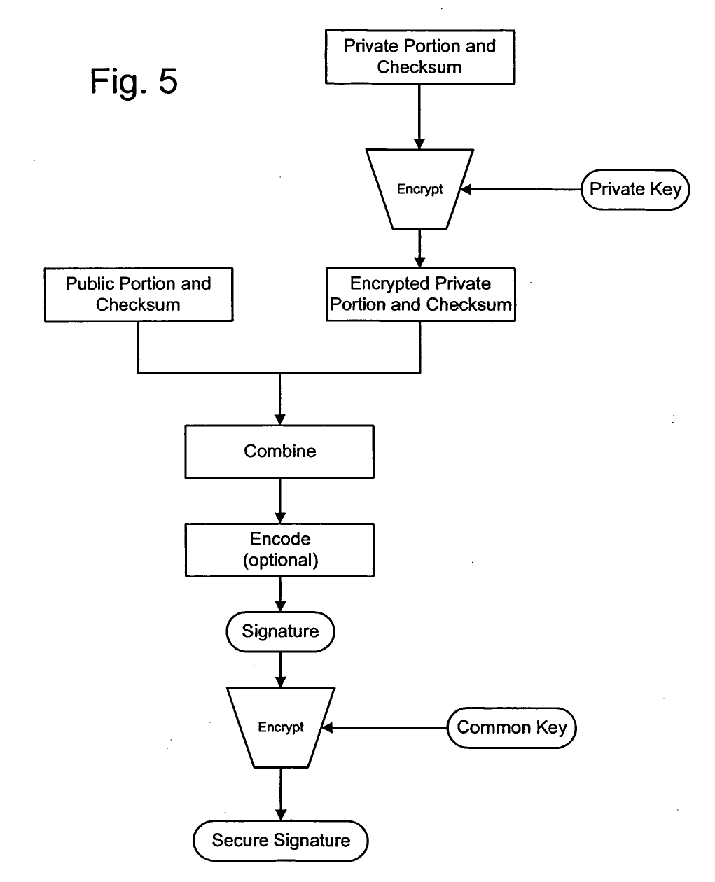

FIG. 5 illustrates an encoding process to facilitate both public and private messages. A watermark payload is segregated or divided into two parts—a “public” portion and a “private” portion. The public and private portions can be separately provided to a watermark payload generator (or formatter). Alternatively, a message is provided to the generator, and the generator separates the message into public and private portions. In other cases, the watermark generator has stored therein (or at least accessible to the embedder) a party or jurisdiction specific identifier or message. For example, the message may be a data record number or governmental database index number. As their names imply, the private portion includes or links to information that is sensitive or private (e.g., a person's medical record or social security number) while the private portion includes less sensitive or public information (e.g., name, birth date, address, driver's license number, etc.).

The private portion preferably includes a checksum (e.g., Cyclic Redundancy Check (CRC)) or other error correction bits associated therewith. A CRC is an error detection mechanism, and provides a validation mechanism for the message portions. Of course there are many other checksum processes that can be suitably interchanged with this aspect of the invention. The private portion and its checksum are encrypted with a private key (e.g., the private portion and checksum are XOR'ed according to a private key.). To illustrate, suppose that the private portion is associated with a particular Jurisdiction—“New America.” The private key is then preferably uniquely associated New America.

The encrypted or scrambled private portion is combined with the public portion. (Of course, while not necessary, we prefer that the public portion also includes a checksum or other error detection mechanism.). There are many different ways to combine the public and private portions. For example, the two portions can be concatenated or appended; or bits or segments from one portion can be interlaced with bits or segments of the other portion in a predetermined manner, etc. The combined portions are optionally subjected to error correction encoding, e.g., convolutional coding followed by tail weighted repetitions, to create a “signature.” The signature bit size can vary from application to application. We currently prefer that the signature bit size be in a range of 256-3072 bits, and most prefer that the signature includes 1024 bits. The signature is then encrypted or scrambled with a public or common key (e.g., a common XOR key). Unlike the private key, the common key is common to a plurality of different entities or jurisdictions—allowing wide access to the public portion. The encryption preferably yields a “secure” signature, preferably including the same number of bits as the unencrypted signature.

The secure signature is embedded as a watermark payload in media. The media can be printed (e.g., on an identification document) or electronically stored.

While the above FIG. 5 encoding focuses on a single private key and a single public key, the invention is not so limited. Indeed, we envision implementations having multiple private keys coupled with a common key. For example, an identification document (e.g., a driver's license) may include a first portion that is encrypted with a first private key associated with a county or city, and a second portion that is encrypted with a second private key associated with a State or other issuing authority. Both the encrypted first portion and the encrypted second portion are combined with a third—and public—portion. The combined portions are then encrypted with a common key to yield a secure signature.

Also, while FIG. 5 shows that the private portion and its checksum are both encrypted, an alternative implementation would encrypt only the private portion and then append the checksum to the encrypted portion. (Or, as a further alternative, a checksum is created for the encrypted first portion.).

Decoding

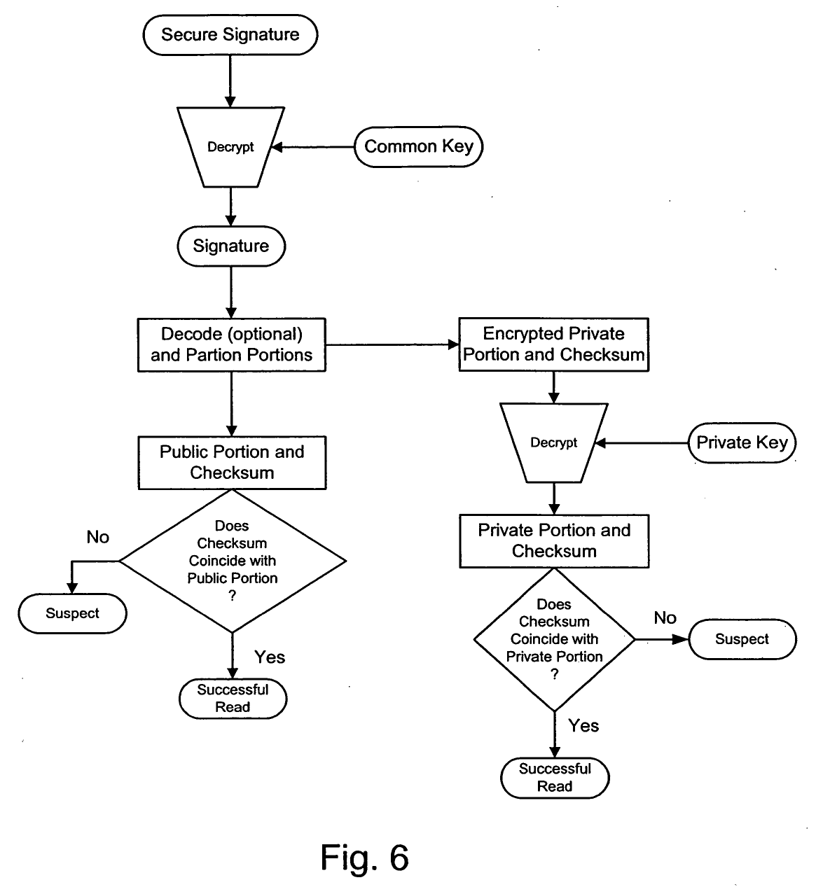

FIG. 6 illustrates a related decoding method.

Embedded media is obtained for analysis. For example, if a watermark is embedded in printed media or provided on a physical object, an optical scan of the media captures image data of the printed media or other physical object. The watermark is decoded from the image data to obtain an embedded secure signature.

The secure signature is decrypted with a corresponding common or public key (e.g., a corresponding XOR key). The decrypted signature is optionally error correction decoded, if the signature includes error correction coding (e.g., the error correction decoding undoes any weighted repetitions or convolutional encoding). The public and private portions are separated or partitioned, e.g., by a bit or segment separation or undoing any interlacing of the portions or bits. The public portion's checksum (e.g., CRC) is checked against its corresponding message. The public portion is successfully read when the checksum coincides in an expected manner. Otherwise the public message—and any underlying media—is considered untrustworthy or suspect.

To obtain the private portion, a corresponding private key is used to decrypt the scrambled private portion (e.g., the encrypted private portion is XOR'ed with a corresponding key). The checksum is checked against its message portion. The private portion is accessible when the checksum coincides in an expected manner. Otherwise, the private portion is considered suspect. Thus, a corresponding private key is required to successfully read the private portion. For example, if a wrong or mismatched key is used, a checksum mismatch occurs and the correct message portion cannot be ascertained, leading to an unsuccessful read of the private portion.

Consider a few applications of our techniques.

A jurisdiction issues an identification document. The identification document includes a digital watermark embedded therein. The watermark has a message that includes a public portion and a private portion. The private portion is encrypted with a private key that is uniquely associated with the jurisdiction. The private portion is successfully decrypted using a corresponding private decryption key.

To successfully decrypt the private portion, a decoder includes a corresponding decryption key. The decoder uses the expected private decryption key to decrypt the private portion and checksum from the identification document. If the checksum corresponds to its message, then the message is successfully interpreted. The private portion (and the underlying identification document) is considered suspect or tampered with when the private key does not yield a checksum match. Moreover, the private portion may include sensitive information (e.g., a document bearer's social security number or other private information). The sensitive information is safeguarded by the private encryption.

In some implementations each of the public portion (and checksum) and private portion (and checksum) must coincide in order for the document to be considered authentic.

Another example envisions that multiple jurisdictions (e.g., the 50 United States) each deploy identification documents using the above public and private protocol. Each jurisdiction includes a unique private key. A private key per jurisdiction allows each jurisdiction to issue a private code (or message portion). The private code is only accessible by an entity having the jurisdiction's corresponding private decryption key. Each jurisdiction includes a public portion embedded in their identification documents. The public portion (along with the encrypted private portion) is encrypted using a common or universal key. Each of the jurisdictions encrypt with the same common or universal key. A common or universal decryption key is used to access the public portion of all jurisdictions. The public portion is thus accessible by any entity including the common decryption key. The public portion may include non-sensitive (or only semi-sensitive) information, e.g., identification number, name, birth date, etc.

Computerized readers may be deployed that include corresponding decryption keys for each of the multiple jurisdictions. Upon encountering an encrypted private payload portion, a reader cycles through each of its stored decryption keys—attempting to successfully decode the encrypted private portion. Success is determined when the reader decrypts the payload with a key and then determines a checksum match. A corresponding jurisdiction is determined by identifying which of the jurisdictions is associated with the successful decryption key. The determined corresponding jurisdiction can then be correlated with information (e.g., a jurisdiction identifier) contained in a watermark, OCR, magstripe, or barcode on the identification document. Thus, the reader can authenticate an identification document through a private decryption key, and/or identify a corresponding jurisdiction via its unique decryption key.

Now, by way of further example, say that Idaho issues an identification document including a watermark embedded therein. The watermark includes a public portion and private portion as discussed above. A bearer of the identification document is driving in Oreg. A stroke of unfortunate luck finds the bearer pulled over by a police office on I-5 for exceeding a 55 MPH posted speed limit by a whopping 6 MPH. The police officer is equipped with a watermark detector. The detector detects the watermark from the bearer's identification document and decodes the watermark to obtain a secure signature. The detector includes the common decryption key, which is used to obtain the public information. This information is used to validate the identification document (see, e.g., assignee's U.S. patent application Ser. No. 10/686,495—published as US 2004-0181671 A1) or populate fields in an electronic ticket. Unless Idaho has shared its private decryption key with the Oregon State Police (as discussed in the above Reader example), the private payload remains unintelligible to the police officer. A few days later, however, the bearer presents herself to the city clerk's office in Boise, Id. The bearer wishes to obtain a concealed weapon permit. The city clerk scans the bearer's identification document with a watermark detector. The detector includes the common decryption key and the private decryption key. The private decryption key is used to decode the private portion. The private decryption key successfully decodes the private portion, and after a successful checksum match, the document is considered authentic. The private information includes additional information evidencing or linking to the bearer's criminal record. It turns out that the bearer is a felon, which disqualifies the bearer from obtaining the concealed weapon permit.

In addition to the combinations outlined in the claims, a few possible combinations from the above disclosure include:

A. A steganographic message generating method comprising:

receiving a first message portion;

receiving or determining a first checksum that is associated with the first message portion;

encrypting the first message portion with a first key;

appending the first checksum to the encrypted first message portion;

receiving a second message portion;

receiving or determining a second checksum that is associated with the second message portion;

combining the encrypted first message portion, the first checksum, the second message portion and the second checksum to yield a signature;

encrypting the signature with a second key; and

steganographically embedding the encrypted signature in media.

A1. The combination of A further comprising error correction encoding the signature prior to said encryption of the signature.

A2. The combination of any one of A and A1 wherein the first key is uniquely associated with a jurisdiction or entity.

A3. The combination of any one of A-A2 wherein the second key is common to a plurality of jurisdictions or entities.

Appending Information to Digital Watermark Payloads

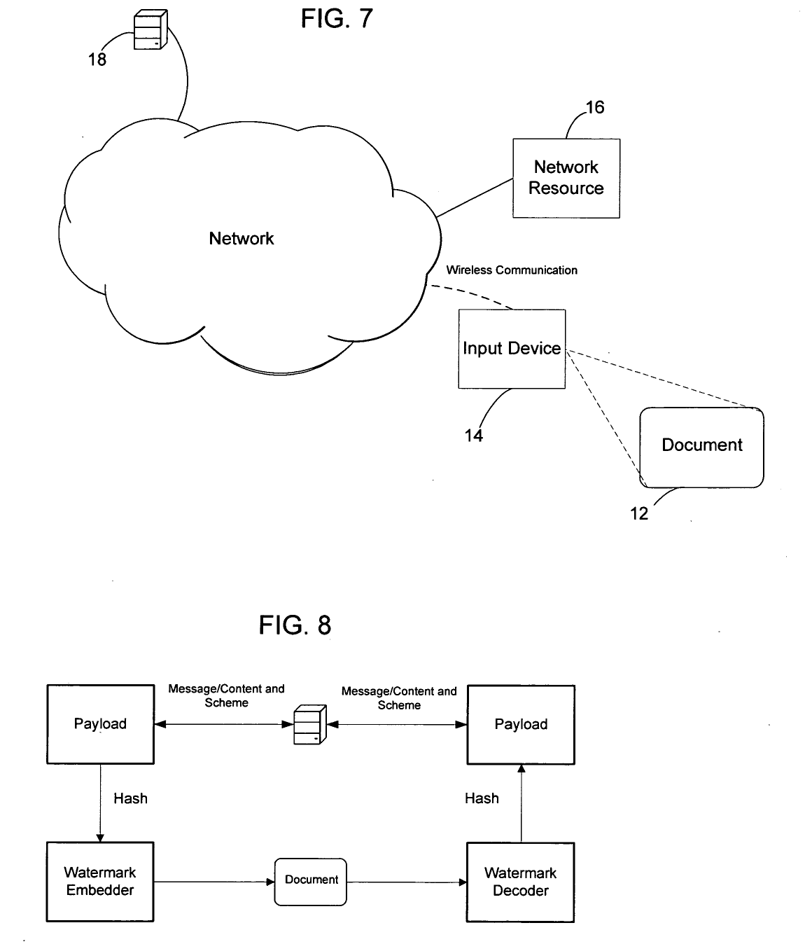

With reference to FIG. 7, a document 12 includes plural-bit digital data steganographically encoded therein (e.g., by digital watermarking). The document 12 can be a photo ID (e.g., a driver's license, student ID, identification card, or passport, etc.), a value document (e.g., a banknote, stock certificate, check or other financial instrument), a trading card (e.g., baseball card, sports card, game card, character card, etc.), a magazine or newspaper article, advertisement, promotional, flier, stationary, envelope, letterhead, product package or label, candy wrapper, a credit card, a product manual, business card, bank or debit account card, printed document, picture, artwork image, registration card, or virtually any other type of document. (In some embodiments, document 12 represents another physical object such as a coffee cup, napkin, menu, soda pop can, jewelry, hardware, souvenir, key chain, license plate, etc.).

The encoding of the document 12 can encompass artwork or printing on the document 12, the document's background, a laminate layer applied to the document, surface texture, etc. If a photograph, graphic or image is present, it too can be encoded. A variety of watermark encoding techniques are detailed in the above cited patent documents; artisans in the field know many more.

In an illustrative embodiment, document 12 is encoded with a plural-bit payload. The payload preferably includes a plurality of fields. The fields need not be physically separated; but, instead, certain bits within a bit-string can be interpreted according to predefined “fields.” An example payload format or scheme is provided below in Table 1:

TABLE 1
Watermark Payload Scheme

| | |
|---|---|
| Scheme Indicator | Message |

The payload includes a first field (or predetermined bits) to identify a watermark payload type or scheme. The type or scheme dictates how the remaining portion of the payload should be interpreted. For example, if type 1, the payload includes a message portion. Or if type 2, the payload includes a plurality of fields that should be interpreted according to the type 2 predetermined format. (As an example, one format is an XML protocol, where the scheme indictor reveals how to interpret the message portions or tags. Another protocol is a WAL—or wireless markup language—where a user can provide tags or components.) Input device 14 communicates with a network resource 16. For example, if the input device 14 includes a camera equipped cell phone, the network resource 16 may include a cellular service provider. Of course, instead of wirelessly communicating (e.g., via cell towers) with resource 16, as shown in FIG. 7, input device 14 may communicate over wires or over a wire and wireless combination.

Network resource 16 includes a computer and information routing capability. (One example of a network resource is a cellular network or a portion of a cellular network. A cellular network is divided into cells, with each cell communicating with a network switching office. The network switching office keeps track of where a cell phone is currently located, according to cell location, so it knows where and through which cell to communicate with. Each cell phone includes a unique identifier—also called an electronic serial number (ESN). The unique identifier is used by the cellular network to uniquely track and communicate with the cell phone.) Input device 14 communicates identifying information (e.g., a device identifier) to network resource 16, so network resource 16 knows who or at least how to communicate with input device 14. For example, network resource 16 receives a message from input device 14 and determines which user or device the network is communicating with.

Network resource 16 preferably facilitates communication, e.g., internet based communication, for the input device 14. Internet-based communication may conform to the WAP standards and specifications or other handheld device communication or internet protocol.

The encoded document 12 is presented to input device 14 for image capture. The preferred image capture device 14 is a handheld device like a camera equipped cell phone or personal digital assistant. (Of course, the input device 14 can take various alternative forms, including a flatbed scanner, a hand scanner (including an imaging mouse), a video camera, a digital camera, a web cam, a digital eye, optical sensor, image sensor, a CMOS or CCD sensor, etc.). Input device 14 includes or communicates with a digital watermark decoder. The decoder can take many different physical forms, but will most often include a processor executing watermark detection software instructions, or dedicated watermark detection processing circuitry. The decoder analyzes image data captured by input device 14 to decode a digital watermark to obtain the digital watermark payload (e.g., as shown in Table 1 above).

Before communicating the watermark payload to the network resource 16, the input device optionally appends information to the watermark payload. For example, the input device 16, appends information regarding time, device location (via GPS coordinates), device type, user preferences, user biometric, past user usage (as defined by content received or rendered by the input device 14), user demographics, etc. The appended information may even instruct the network resource how to handle the message. The input device 14 (or watermark decoder) can use a watermark's scheme indictor to dictate how to amend the information in accordance with the corresponding scheme. A resulting message format is shown below in Table 2. (An illustrative example employs an XML or WAL protocol, where appended information populates a predefined—but empty—tag, or where a new tag or content portion is provided.)

TABLE 2
Input Device Appending Information to a Watermark Message

| | | |
|---|---|---|
| Scheme Indicator | Message | Input Device |
| | | Appended Information |

Of course, in other implementations, the input device 14 reduces the original payload before forwarding onto the network resource. For example, the scheme indicator may indicate that the message includes redundancies therein. The input device may grab a first instance of the redundant information and append information only to the first instance. Or, the message may include a plurality of fields or tags and the detector may only forward on a subset of the fields or tags, with any appended information. (The input device 14 may also optionally signal the network resource 16 (or other entity) to expect a payload and/or what actions to perform in response to the payload. For example, input device 14 may send a URL or database locator, which can be used by network resource 16, or an entity in communication with the network resource 16, to communicate with a data resource 18 or website.) Or the scheme indicator may help to provide information to a guest network, where a cell phone may find itself as a roaming guest.

Input device 14 communicates the appended payload (e.g., Table 2) to the network resource 16.

Network resource 16 may also append information the payload prior to directing the payload to data resource 18. The network appended information may include, e.g., network protocols, user or network demographics, input device location (as determined by the network), user or device past activity, contact information, user supplied information (e.g., user survey results or user defined preferences), etc. The information can be appended according to the scheme identified by the scheme indicator. A resulting message format is shown below in Table 3.

TABLE 3
Network Router Appending Information to a Watermark Message

| | | | |
|---|---|---|---|
| Scheme Indicator | Message | Input Device | Network Resource |
| | | Appended | Appended |
| | | Information | Information |

The appended payload is forwarded to data resource 18 through a network. (In some implementations data resource 18 is co-located with network resource 16.). Data resource 18 includes a plurality of information accessible via payload messages or identifiers. Thus, upon receipt of the appended message, data resource 18 searches its records or index to locate data corresponding to the message portion of the appended payload. The located data may include, e.g., a URL, metadata, multimedia content, an audio or video file, HTML, XML, WAL, etc. The located data is returned, via network resource 16, to input device 14. The data resource 18 can use the remaining appended information in any manner it sees fit, included recording the information to establish patterns or commercial activity surrounding the located data stored. (For example, say document 12 is an advertisement for a new Sports Utility Vehicle (SUV). The document includes a message that is associated via the data resource 18 to a URL. The URL points to a web page featuring the SUV. After decoding a digital watermark from document 12, an input device 14 and/or network resource 16 appends information to the payload. Some of the appended information includes an age group or gender indicator. The data resource 18 stores the age group and/or gender indicator to report back to the advertiser who produced the advertisement. The reported information is used by the advertiser to determine whether the advertisement is reaching an intended audience or as input for further advertisements.).

The network resource 16 can also track information. For example, the network resource 16 maintains a database of payload messages, appended information and any corresponding information (e.g., URL, HTML, XML, etc.) provided back from data resource 18. This information can be similarly provided to advertisers or others interested in the usage and corresponding information. (Of course, we imagine that the usage history and corresponding information can be stored by either the network resource 16 or data resource 18 in a manner to protect the identity of the user. That is, the recordation of usage, demographics, user preference, content accessed is preferably achieved in a manner to protect a user's privacy and identity.).

As an alternative arrangement, a user provides user preference, device settings, demographic information, etc. to network resource 16 in advance of watermark decoding (e.g., during service registration). Network resource 16 then appends this information to a received watermark payload, instead of input device 14.

With reference to FIG. 8, we discuss a payload generation method and system. A payload is provided. The payload may include a variety of different information—which is the beauty of this system. In some cases the payload is a 56-1024-bit binary number, in other cases the payload is a text file or audio file. The payload is communicated to a data repository, which stores the payload and generates a corresponding hash of the payload. Regardless of a payload input, a resulting hash includes a standardized bit-length, allowing for a standardization of any information or payload. (Of course, different-bit size hashes or different hash formats can be generated, and scheme identifier can be provided to help a watermark embedder or decoder during embedding.) The hash is communicated to a watermark embedder, which embeds the hash in an object like a document or electronic file.

A watermark decoder analyzes data corresponding to the document (e.g., optical scan data) to recover the hash. The hash and any payload scheme information can then be used (e.g., by a cooperating software application) to interface with the data repository. The original payload is retrieved and provided for use. Our system allows for the standardization of payload formats according to scheme or payload structures.

In addition to the combination detailed in the claims, a few possible combinations from the above disclosure include:

A. A method of compiling information associated with a digital watermark message, wherein the message is embedded in a physical object, said method comprising:

receiving the watermark message after it has been decoded by a first device, wherein the watermark message comprises at least first information appended or combined therewith, and wherein the first information is appended or combined with the watermark message by a second and different device;

identifying data associated with the watermark message;

recording the first information and the watermark message in a data record.

A1. The combination of A wherein the first device comprises a cell phone, and the second device comprises a component in a cellular network.

A2. The combination of A further comprising recording identifying data that is associated with the watermark message in the data record.

B. A method of appending information to a digital watermark message comprising:

receiving at a first device a digital watermark message that has been decoded by a remote second device, wherein the digital watermark message includes information identifying a protocol or format associated with the digital watermark message;

appending or combining information to the digital watermark message in accordance with the protocol or format;

communicating the appended or combined digital watermark message from the first device to a remote third device.

B 1. The combination of B wherein the information comprises usage information associated with the first device or a user of the second device.

B2. The combination of B wherein the information comprises user preferences of a user associated with the second device.

B3. The combination of B wherein the information comprises demographics associated with a user of the second device.

B4. The combination of B wherein the information comprises at least one of device type, network protocol and a current location associated with the first device.

B5. The combination of any one of B-B4, further comprising receiving information from the third device that is associated with the digital watermark message, and forwarding the information to the second device.

B6. The combination of B5 further comprising: at the first device, recording in a data record the message and appended information.

B7. The method of claim B6 further comprising: at the first device, recording in the data record the information received from the third device.

C. A method to generate data for embedding as a digital watermark component, said method comprising:

receiving first information having a first bit-size;

hashing the first information to provide a first reduced-bit representation of the first information, the first reduced-bit representation comprising a second bit-size;

storing the first information in a data repository to be indexed according to the first reduced-bit representation;

providing the first reduced-bit representation of the first information for embedding as a digital watermark component;

receiving second information having a third and different bit-size;

hashing the second information to provide a second reduced-bit representation of the second information, the second reduced-bit representation comprising the second bit-size;

storing the second information in a data repository to be indexed according to the second reduced-bit representation; and

providing the second reduced-bit representation of the second information for embedding as a digital watermark component.

C1. The combination of C wherein a message format indicator is provided with each of the first reduced-bit representation and the second reduced-bit representation.

D. A method of compiling information associated with a steganographic watermark message comprising:

receiving the watermark message, wherein the watermark message comprises first information and second information appended or combined therewith, and wherein the first information is appended or combined with the watermark message by a first device and the second information is appended or combined with the watermark message by a second device;

identifying data associated with the watermark message;

recording the first information, second information and the watermark message in a data record.

D1. The method of D wherein at least one of the first information and the second information comprises at least one of user information, past usage information and demographic information.

D2. The method of D further comprising recording identifying data that is associated with the watermark message in the data record.

D3. The method of D wherein the first device comprises a cell phone.

Concluding Remarks

Having described and illustrated the principles of the technology with reference to specific implementations, it will be recognized that the technology can be implemented in many other, different, forms. The variable message coding protocols may be used in digital watermarking applications where digital watermarks are embedded by imperceptibly modifying a host media signal. They may also be used in steganographic applications where message are hidden in media signals, such as images (including graphical symbols, background textures, halftone images, etc.) or text. The embedding or encoding of the message according to the variable protocols may, in some cases create visible structures or artifacts in which the message is not discernable by a human, yet is readable by an automated reader with knowledge of the protocol, including any keys used to scramble the message.

To provide a comprehensive disclosure without unduly lengthening the specification, applicants incorporate by reference the patents and patent applications referenced above.

The methods, processes, and systems described above may be implemented in hardware, software or a combination of hardware and software. For example, the auxiliary data encoding processes may be implemented in a programmable computer or a special purpose digital circuit. Similarly, auxiliary data decoding may be implemented in software, firmware, hardware, or combinations of software, firmware and hardware. The methods and processes described above may be implemented in programs executed from a system's memory (a computer readable medium, such as an electronic, optical or magnetic storage device).

The particular combinations of elements and features in the above-detailed embodiments are exemplary only; the interchanging and substitution of these teachings with other teachings in this and the incorporated-by-reference patents/applications are also contemplated.

1. A message generating method comprising:
receiving a first message portion comprising a first checksum associated therewith;
encrypting the first message portion with a private key;
receiving a second message portion comprising a second checksum associated therewith;
combining the encrypted first message portion with the second message portion to yield a signature;
encrypting the signature with a common key; and
steganographically embedding the encrypted signature in media.

2. The method of claim 1, wherein the first checksum comprises error correction coding.

3. The method of claim 1, wherein the second checksum comprises error correction coding.

4. The method of claim 1, wherein the first checksum comprises a Cyclic Redundancy Check (CRC).

5. The method of claim 1, wherein the second checksum comprises a Cyclic Redundancy Check (CRC).

6. The method of claim 1, wherein the private key is uniquely associated with a jurisdiction or entity.

7. The method of claim 1, wherein the common key is to be commonly used by more than one jurisdiction or entity.

8. The method claim 1, wherein prior to encrypting the signature with the common key, said method comprises error correction coding the signature.

9. The method of claim 1, further comprising printing the media on a physical object.

10. A method of validating the physical media of claim 9, comprising:
receiving optical scan data representing at least a portion of the physical media;
analyzing the scan data to obtain the encrypted signature;
decrypting the encrypted signature with a decryption key corresponding with the common key;
obtaining the encrypted first message portion from the decrypted signature;
decrypting the encrypted first message portion with a decryption key corresponding with the private key;
determining whether the first message portion and the first checksum correspond in an expected manner.

11. The method of claim 10, further comprising determining whether the second message portion and the second checksum correspond in an expected manner.

12. The method of claim 10, wherein a computer processor executing the method generates the first and second checksums.

13. A method of securing steganographic messages in a system including a first party and a second party, said method comprising:
providing the first party with a first unique encryption key;
providing the second party with a second unique encryption key; and
providing each of the first party and the second party with a common encryption key,
wherein steganographic media associated with the first party includes a message including encryption by the first encryption key and the common encryption key, and
wherein steganographic media associated with the second party includes a message including encryption by the second encryption key and the common encryption key.

14. The method of claim 13, wherein the media comprises identification documents.

15. An identification document comprising:
a photographic representation of a bearer of the identification document;
a background or graphic;
a first digital watermark embedded in the photographic representation;
a second digital watermark embedded in the background or graphic,
wherein at least one of the first digital watermark and the second digital watermark comprises a message, the message comprising:
a first portion and a first checksum associated therewith, wherein at least the first portion is encrypted with a first encryption key, and
a second portion including a second checksum associated therewith, and
wherein at least the second portion and the encrypted first portion are encrypted with a second encryption key.

16. The method of claim 15, wherein the encryption is based on an XOR key.

17. The method of claim 15, wherein the encryption is based on a scrambling sequence, the result of the encryption yielding an encrypted signature having the same bit length as the signature.

18. A watermark reader comprising:
electronic processing circuitry;
a communications bus;
memory in communication with said electronic processing circuitry via said communications bus, said memory including executable instructions to:
decrypt an encrypted portion of a watermark payload by individually using a plurality of decryption keys, wherein each decryption key is uniquely associated with a document issuing jurisdiction;
identify a corresponding decryption key through successful decryption of the encrypted portion of the watermark payload; and
identify a document issuing jurisdiction that is associated with the decryption key.

19. The watermark reader of claim 18, wherein said identify a corresponding decryption key through successful decryption of the encrypted portion of the watermark payload comprises analysis of a checksum match.

20. The watermark reader of claim 18 wherein the watermark payload is carried by an identification document, and wherein said executable instructions further comprise instructions to:
authenticate the identification document by reference to at least the identified jurisdiction.

21. The watermark reader of claim 18, wherein said instructions to authenticate cross-correlates the identified jurisdiction with machine-readable indicia carried by the identification document.

22. The watermark reader of claim 21, wherein the machine-readable indicia comprises at least one of a digital watermark, a bar code, a data matrix, optical character recognition, magnetic stripe, and indicia carried by optical memory or electronic memory circuits.

23. A method of appending information to a digital watermark message comprising:
receiving at a first device a digital watermark message that has been decoded by a remote second device;
appending or combining demographic information to the digital watermark message, wherein the demographic information is associated with a registered user of the first device; and
communicating the appended or combined digital watermark message to a remote third device.

24. The method of claim 23 wherein the demographic information comprises at least one of: i) usage information associated with the first device or the registered user; ii) user preferences of the registered user; iii) age; iv) place residence; and v) gender.

25. The method of claim 23 further comprising receiving information from the third device that is associated with the digital watermark message, and forwarding the information to the second device.

26. The method of claim 23 wherein the message comprises at least one of a XML format and a WAL format.
